(19) United States
(12) Patent Application Publication
(10) Pub. No.: US 2024/0426580 A1
(43) Pub. Date: Dec. 26, 2024

(54) POSITION LOCATOR SYSTEMS

(71) Applicant: University of Central Florida Research Foundation, Inc., Orlando, FL (US)

(72) Inventors: Dean Reed, Titusville, FL (US); Devyn Dodge, Orlando, FL (US)

(73) Assignee: University of Central Florida Research Foundation, Inc., Orlando, FL (US)

(21) Appl. No.: 18/417,074

(22) Filed: Jan. 19, 2024

Related U.S. Application Data
(60) Provisional application No. 63/441,365, filed on Jan. 26, 2023.

(51) Int. Cl. F41G 3/26; G06F 3/01

(52) U.S. Cl. CPC F41G 3/26; G06F 3/016

(57) ABSTRACT

A real-time position location system can include one or more location modules configured to be attached to a user or a weapon of the user and to output location data associated with each user and one or more kinematic base station modules configured to receive the location data from each location module. The system can include a position module operatively connected to the one or more kinematic base stations and configured to determine a real-time location of each of the one or more location modules and to output module position data for each of the one or more location modules in real-time.

### CROSS-REFERENCE TO RELATED APPLICATIONS

This application claims priority to and the benefit of U.S. Provisional Application No. 63/441,365, filed on Jan. 26, 2023, the entire contents of which are herein incorporated by reference in its entirety.

### STATEMENT OF GOVERNMENT RIGHTS

This invention was made with government support under contract no. W912CG-21-C-0010 LIVE and W911NF-15-2-0099 awarded by the Department of the Army. The government has certain rights in the invention.

### FIELD

This disclosure relates to position locator systems.

### BACKGROUND

Conventional methods and systems with respect to position locator systems have generally been considered satisfactory for their intended purpose. However, there is still a need in the art for improvements. The present disclosure provides a solution for this need.

### SUMMARY

A real-time position location system can include one or more location modules configured to be attached to a user or a weapon of the user and to output location data associated with each user and one or more kinematic base station modules configured to receive the location data from each location module. The system can include a position module operatively connected to the one or more kinematic base stations and configured to determine a real-time location of each of the one or more location modules and to output module position data for each of the one or more location modules in real-time.

The system can include one or more weapon tracking modules operatively associated with the weapon of the user and configured to provide weapon data to the one or more kinematic base station modules in real-time. The weapon data can include a trigger fire data that indicates whether a simulated shot has occurred, and a weapon orientation that indicates a directionality of the simulated shot.

The system can include a shot adjudication module operatively connected to the one or more kinematic base station modules to receive the weapon data of an associated user and the module position data of the associated user in real-time and to output shot trajectory data of the simulated shot based on the weapon data and the module position data of the associated user when the simulated shot occurred. In certain embodiments, the adjudication module can be locally hosted on the one or more kinematic base stations.

The system can also include a hit module configured to receive the shot trajectory data and the position data of a second user and to determine if a position of the second user intersects the simulated shot in real-time based on the shot trajectory data to determine if the second user has been virtually hit by the simulated shot. In certain embodiments, the hit module can include a terrain map and is configured to determine whether the second user is obscured by terrain such that the shot intersects terrain in front of the second user. The hit module can be configured to determine an effect of the terrain and whether the shot would hit the second user through the terrain.

In certain embodiments, the one or more location modules include an acoustic and/or haptic feedback system configured to alert the wearer of one or more events through acoustic and/or haptic feedback. The feedback system can be configured to notify a user if they are hit by a simulated shot (e.g., through a hit signal from the one or more kinematic base stations), or whether the user is out of bounds (e.g., in a hazard area or any suitable predefined boundaries).

The one or more location modules can include a digital radio for bi-directional communication with the one or more kinematic base-station modules to provide localization enhancement to have precision within about a centimeter. The one or more location modules can include one or more sensors configured to output sensor data to determine one or more user characteristics. The one or more user characteristics can include at least one of head orientation, velocity, or local pressure conditions. Each location module can be configured to communicate its location data and sensor data over the digital radio to allow determination of ground truth location and orientation of the user. In certain embodiments, the one or more sensors include one or more inertial measurement units (IMU's) and/or one or more camera vision systems configured to provide motion data and/or position data, e.g., when external location systems (e.g., GPS) are inaccurate (and the IMUs and/or camera vision systems can deactivate when not needed, e.g., when precise GPS is available, for example).

The one or more location modules can include an internal battery. In certain embodiments, the one or more location modules can be configured to operate in a low power mode to enable use over multiple days without recharging. In certain embodiments, the low power mode can include intermittent listening for signals and/or intermittent transmission of signals. In certain embodiments, the one or more location modules can be configured to operate in a low power beacon mode configured to output intermittent beacon signals to locate a user in distress. In certain embodiments, the one or more location modules can be configured to intermittently listen for a finder signal, and to output an acoustic signal as the finder signal is heard by the one or more location modules to help locate a user in distress.

In certain embodiments, the one or more kinematic base station modules include a housing having a pole mount. For example, the pole mount can be a threaded opening. The pole mount can be configured to receive a standard survey pole.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic diagram of an embodiment of a system in accordance with this disclosure;

FIG. 2A is a perspective view of an embodiment of a location module in accordance with this disclosure;

FIG. 2B is a rear perspective view of the embodiment of FIG. 2A;

FIG. 3A is an elevation view of an embodiment of a kinematic base station module in accordance with this disclosure;

FIG. 3B is a transparent elevation view of the embodiment of FIG. 3A;

FIG. 4A illustrates an embodiment of the system of FIG. 1 in use as a personnel tracker;

FIG. 4B illustrates the embodiment of FIG. 4A, showing a simulated shot intersecting a second user; and

FIG. 4C illustrates the embodiment of FIG. 4A, showing a simulated shot intersecting a terrain item.

### DETAILED DESCRIPTION

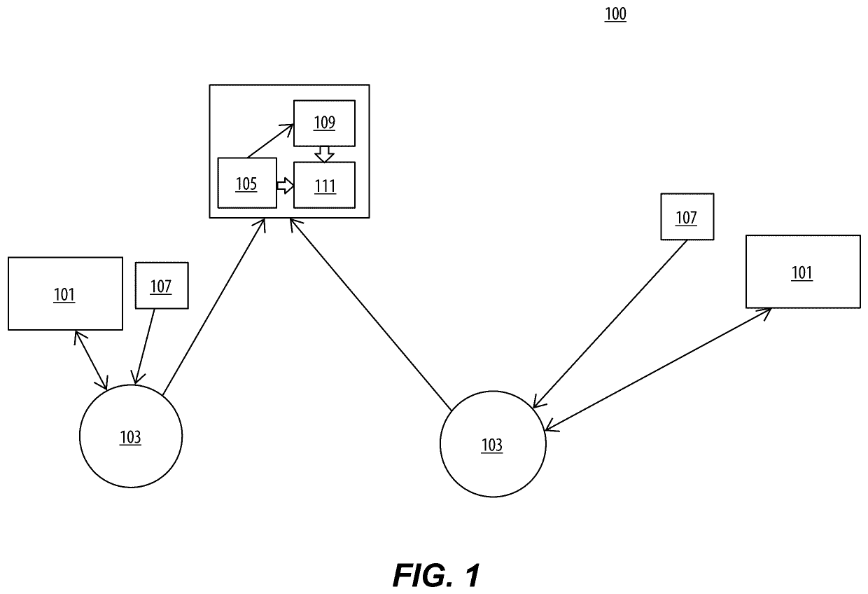

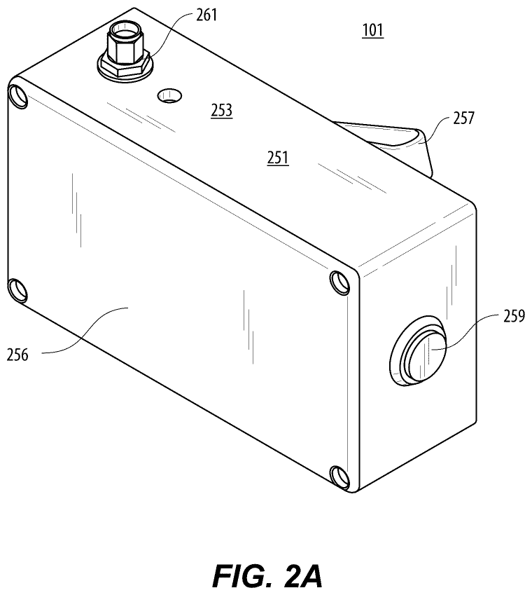

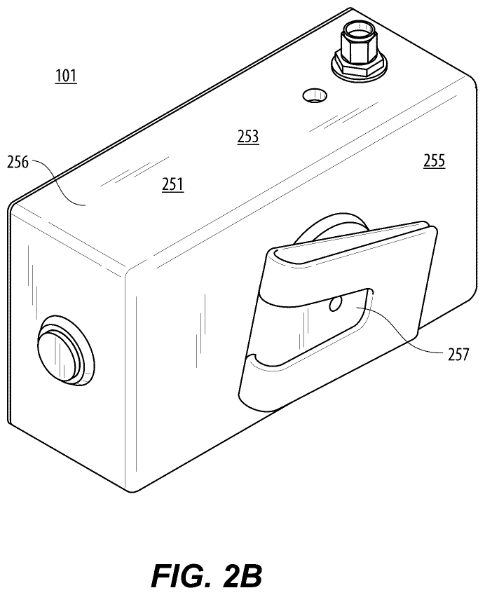

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. Other embodiments and/or aspects of this disclosure are shown in FIGS. 2A-4C.

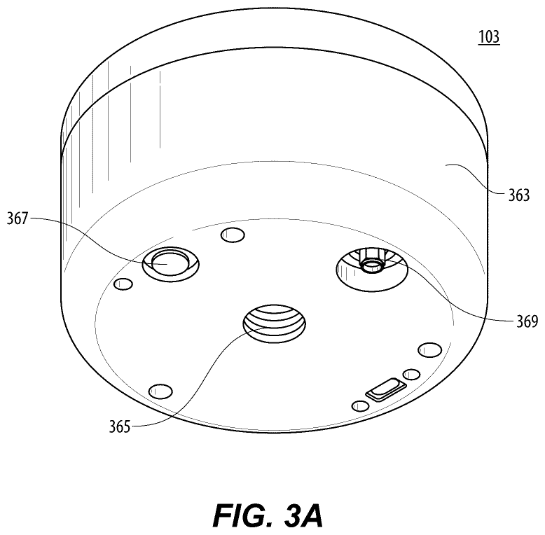

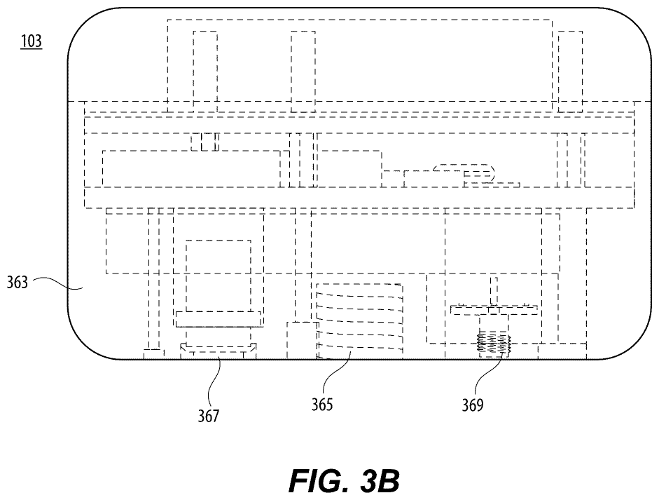

Referring to FIG. 1, in accordance with at least one aspect of this disclosure, a real-time position location system 100 can include one or more location modules 101 configured to be attached to a user (e.g., a clip on device as shown in FIGS. 2A and 2B) or a weapon (e.g., attachable to a picatinny rail) of the user and to output location data associated with each user. The system 100 can also include one or more kinematic base station modules 103 (e.g., as shown in FIGS. 3A and 3B) configured to receive the location data from each location module 101. The system 100 can include a position module 105 operatively connected to the one or more kinematic base stations 103 and configured to determine a real-time location of each of the one or more location modules 101 and to output module position data for each of the one or more location modules 101 in real-time. The module position data can be used for tracking the location of an individual for example, or for other processing purposes, e.g., as described below with respect to a military/war simulation and/or military training.

In certain embodiments, referring additionally to FIGS. 2A and 2B, the one or more location modules 101 can include an acoustic and/or haptic feedback system 251 configured to alert the wearer of one or more events through acoustic and/or haptic feedback. The feedback system can be configured to notify a user if they are hit by a simulated shot (e.g., through a hit signal from the one or more kinematic base stations 103), or whether the user is out of bounds (e.g., in a hazard area or any suitable predefined boundaries).

The one or more location modules 101 can include a digital radio 253 for bi-directional communication with the one or more kinematic base-station modules 103 to provide localization enhancement to have precision within about a centimeter. The one or more location modules 101 can include one or more sensors 255 (e.g., an IMU package, and/or GPS configured to output sensor data to determine one or more user characteristics. The one or more user characteristics can include at least one of head orientation, velocity, or local pressure conditions. Each location module 101 can be configured to communicate its location data and sensor data over the digital radio 253 to allow determination of ground truth location and orientation of the user. In certain embodiments, the one or more sensors 255 can include one or more inertial measurement units (IMU's) and/or one or more camera vision systems configured to provide motion data and/or position data, e.g., when external location systems (e.g., GPS) are inaccurate (e.g., below a desired or needed threshold of accuracy). In certain embodiments, the one or more IMUs and/or camera vision systems can deactivate when not needed, e.g., when precise GPS is available, for example.

The one or more location modules 101 can include any suitable housing 256, e.g., as shown, to house any suitable components. As shown in FIGS. 2A and 2B, a location module 101 can include a portable packaging with a clip 257. Any suitable clip type is contemplated herein. Certain embodiments can include a picatinny rail mount, for example. Certain embodiments can include a control button 259 (e.g., for power control, for activating an emergency mode or a low power mode, etc.) and an antenna and/or data connector 261, for example. The housing 256 can be waterproofed and the components can be secured to be shock resistant, for example.

The one or more location modules 101 can include an internal battery (not shown, e.g., 5000 mAh capacity), for example. In certain embodiments, the one or more location modules 101 can be configured to operate in a low power mode to enable use over multiple days without recharging (e.g., with 5000 mAh capacity internal battery). In certain embodiments, the low power mode can include intermittent listening for signals (e.g., once every 90 seconds) and/or intermittent transmission of signals (e.g., once every 10 minutes to transmit location data). In certain embodiments, the one or more location modules 101 can be configured to operate in a low power beacon mode configured to output intermittent beacon signals to locate a user in distress. In certain embodiments, the one or more location modules 101 can be configured to intermittently listen for a finder signal, and to output an acoustic signal as the finder signal is sensed by the one or more location modules 101 to help locate a user in distress. The one or more location modules 101 can include any other suitable components to enable real time kinematics and location determination.

In certain embodiments, referring additionally to FIGS. 3A and 3B, the one or more kinematic base station modules 103 can include a housing 363 having a pole mount 365. For example, the pole mount 365 can be a threaded opening. The pole mount 365 can be configured to receive a standard survey pole, for example (e.g., a tripod). Certain embodiments can include a control button 367 and an antenna and/or data connector 369, for example. The housing 365 can be waterproofed and the components can be secured to be shock resistant, for example. The one or more kinematic base station modules 103 can include any other suitable components to enable real time kinematics.

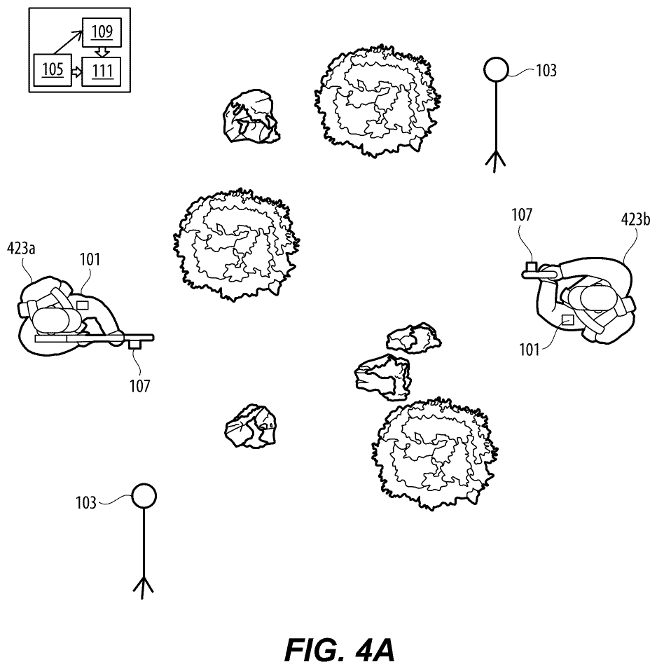

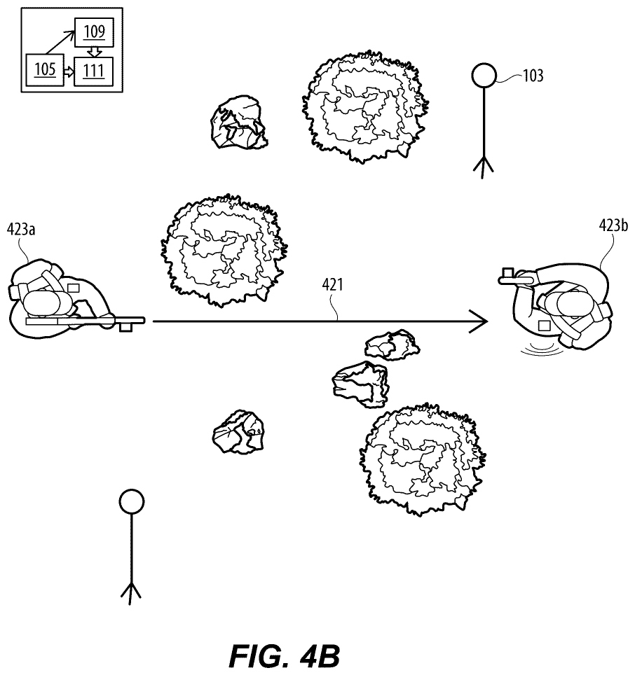

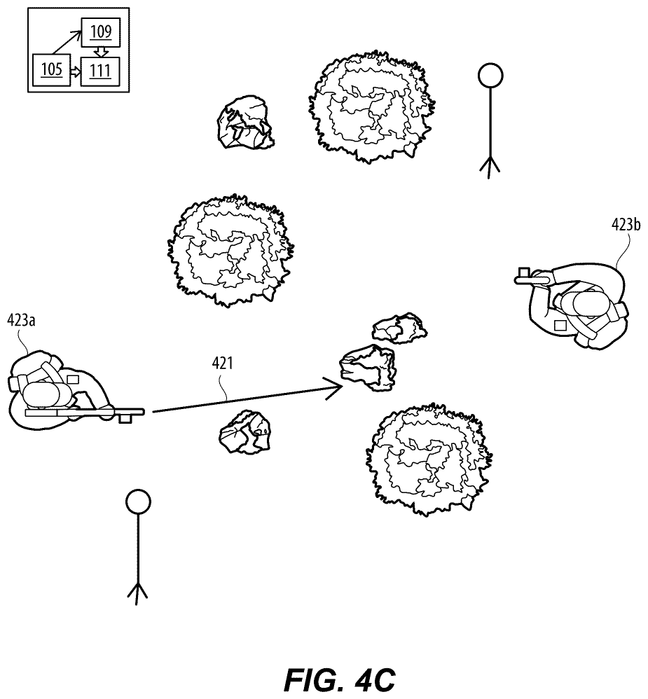

Referring to FIGS. 1 and 4A, 4B, and 4C, in certain embodiments, the system 100 can include one or more weapon tracking modules 107 operatively associated with the weapon (e.g., a firearm) of a respective user 423a, 423b and configured to provide weapon data to the one or more kinematic base station modules 103 in real-time. The weapon data can include a trigger fire data that indicates whether a simulated shot 421 has occurred, for example. The weapon data can include a weapon orientation that indicates a directionality of the simulated shot 421, for example. Any other suitable weapon data to indicate the use or position of the weapon for determine a shot trajectory is contemplated herein. Certain embodiments of a weapon tracking module 107 can be utilized with and/or be integrated with, and/or otherwise be or include a trigger detection module as disclosed in U.S. patent application Ser. No. 17/137,287 filed Dec. 29, 2020, incorporated by reference herein in its entirety.

The system 100 can include a shot adjudication module 109 operatively connected to the one or more kinematic base station modules 103 to receive the weapon data of an associated user 423a and the module position data (e.g., from the position module 105) of the associated user 423a in real-time and to output shot trajectory data of the simulated shot 421 based on the weapon data and the module position data of the associated user 423a when the simulated shot 421 occurred. In certain embodiments, the adjudication module 109 can be locally hosted on the one or more kinematic base stations 103. Any suitable common hosting of any suitable modules disclosed herein is contemplated herein.

The system 100 can also include a hit module 111 configured to receive the shot trajectory data and the position data of a second user 423b and to determine if a position of the second user 423b intersects the simulated shot 421 in real-time based on the shot trajectory data to determine if the second user 423b has been virtually hit by the simulated shot 421 (e.g., as shown in FIG. 4B). For example, as shown in FIG. 4B, the second user 423b is hit by the simulated shot 421 based on the position data of the second user 423b, and an indication (e.g., an acoustic or haptic feedback) is shown activated to indicate the second user 423b is hit. In certain embodiments, the hit module 111 can include a terrain map and is configured to determine whether the second user 423b is obscured by terrain (e.g., rocks or trees as shown) such that the shot intersects terrain in front of the second user 423b (e.g., as shown in FIG. 4C). The hit module 111 can be configured to determine an effect of the terrain (e.g., whether it would stop a munition of the type used, whether it would pass through, whether it would deflect or fragment, etc.) and whether the shot would hit the second user 423b through the terrain, for example. The hit module 111 can output a hit signal to the location module 101 of the second user 423b, e.g., via one or more kinematic base station module 103 to indicate the second user 423b was hit. Any other suitable real-time communication pathway between any suitable modules is contemplated herein.

As shown in FIGS. 4A-4C, the modules 101 and 107 are connected wirelessly to one or more of the kinematic base station modules 103 which provides data in real-time to the position module 105 and the shot adjudication module 109, for example. Any suitable wireless connection is contemplated herein (e.g., two way radio, a network, etc.). The devices 101, 103 can form a mesh network for communication, and the modules 105, 109, 111 can be hosted together at a control module (e.g., connected via internet, satellite, hard wire, etc. to the modules 103).

Certain embodiments can include inertial-only tracking algorithms that can survive loss of GPS and continue to track the players for a period of time after loss of the GPS signal. Such embodiments can leverage one or more onboard inertial measurement units (IMU's) with stochastic pedometric estimates and precise dead reckoning to provide localization in GPS denied areas (e.g., inside buildings, under tree canopy, or in extreme weather conditions). Certain embodiments can utilize a computer vision camera to implement simultaneous localization and mapping (SLAM) in a power efficient way (e.g., such that it is only used when high precision GPS capabilities are denied). Thus, certain embodiments can provide power efficient GPS denied localization utilize suitable hardware and any suitable modules configured to perform the above functions.

Integration of any suitable modules disclosed herein is contemplated herein. Each module can include any suitable computer hardware and/or software to provide real time kinematics.

Certain embodiments can be used for personnel location management, for example. Certain embodiments can integrate to form a training system comprised of a shot adjudication module configured to receive accurate position information from the location module, as well as bullet trajectory/firearm orientation information when fired, e.g., from a trigger detection module, and determine if a shot hit a person wearing a location module (and even where on the person's body relative to the location module in some embodiments).

Embodiments can include a location module that can have intelligence to manage battery life of the for long term use. Certain embodiments can provide a location function that can provide a very accurate position using radio triangulation (e.g., provides position within 5-10 centimeters), using an IMU, using a GPS, and/or using a real-time kinematics network (which can provide position within millimeters). Certain embodiments of a location module can have a location function configured to provide a beacon (e.g., radio for triangulation, GPS, etc.) that, in an emergency mode, can be intermittent and sample on known intervals followed by going dormant in an ultra-low power state (e.g., 10 minutes intervals provides multiple weeks of battery life with a 5000 mAh battery, for example). Embodiments can include an emergency button for broadcasting that the user needs help.

Certain embodiments of a location module can have an audible locator that can be activated manually or automatically by arriving personnel to aid in location of a user (e.g., a “captains wand” can be used to send out a signal to turn on the sound of the location modules in vicinity). Certain embodiments of the location module can listen (e.g., intermittently for power saving) for a signal asking for audible location, and then can output a sound and a signal reporting a last known location, for example. Embodiments can listen more often than transmit because it is less power intensive.

Certain embodiments of a location module can also have an inertial measurement system for dead reckoning information for providing location information in the transmitted location signal (e.g., where GPS is unavailable or denied). This can allow dead reckoning information to provide updated position of a user from a last known position. Certain embodiments of a location module can utilize LORA radio for real-time kinematics.

Certain embodiments of a location module can have haptic capabilities for notifying the user of a certain circumstance, e.g., warnings such as going out of bounds, getting shot, using as a cease fire indicator on a range or during a war simulation, etc. Certain embodiments of a location module provide different type of haptic or audible pulses for different scenarios, e.g., to allow a user to differentiate between a hit indication and an out of bounds warning, for example.

Certain embodiments of a location module or base station module can be configured for universal mounting. In certain embodiments, multiple devices (e.g., base station modules) can be mesh networked together to maintain communications over a wide area. Certain embodiments can be IP67 water resistant and can be compatible with picatinny rails, helmet mounts, and/or be clipped on. Certain embodiments of a location module can have no snag points, for example.

Embodiments of a system as disclosed herein can integrate with a trigger detection module (TDM) to be used in training scenarios. Such devices can work together to provide high quality location with high quality orientation, and then can determine where the shot would go. For example, a user can shoot and a TDM can send a shot signal to adjudication system. Then the adjudication software (e.g., hosted on a network computer and connected remotely to each person via the mesh network of kinematic base station modules). The adjudication software can use the location of the person (e.g., from their location module) and can reference terrain data to determine if a target was hit. The person getting shot at would be hit based on their location from their location module (e.g., assuming a person sized and shaped target) and whether their position (e.g., the simulated area where the person is) intersected the simulated shot. Certain embodiments can determine where on a target's body they were hit based on certain assumptions of where the simulated shot hits relative to the location module (e.g., which is worn in a known location). Embodiments can allow the use of this information for medical training such as smart devices like a smart tourniquet to simulate battlefield response to being shot in a particulate location. Certain embodiments can store all the location information, shots, adjudication data, etc. for review, e.g., play-by-play, at a later time. Certain embodiments of a system can implement logging 30 fields at 90 Hz (e.g., 30 data points at 90 times per second).

Embodiments can be geared toward enabling real-time localization and extended tracking of personnel. While certain use cases of certain embodiments or portions thereof include precise tracking during force-on-force training, certain embodiments of a location module can be designed to manage a location of users over extended periods of time. Certain embodiments of a location module can be a networked component that is complimentary to a high quality weapon tracking component, e.g., a trigger detection module, and a real time kinematic base station module.

Certain embodiments of a location module can include hardware and software support that can alert the wearer of a variety of events through acoustic and haptic feedback. For example, certain embodiments of a location module can be used in live training scenarios where an EBullet approach is used to replace a traditional MILES system to represent a kinematic force-on-force scenario. Certain embodiments of a location module can include a digital radio that enables bi-directional communication with our base-station which provides localization improvements so that centimeter level precision can be achieved. The capability to track individuals can be complemented by a sensor suite that provides a basis to compute navigational algorithms to determine head orientation, velocity and local pressure conditions. Certain embodiments of a location module can communicate its location and supporting data elements over the digital radio to provide ground truth location along with orientation of the wearer.

Certain embodiments of a location module can be implemented to be easily configured for long durations by using a low power mode. A power saving approach that can be useful to track a wearer over multiple days. In effect, certain embodiments of a location module can be used to localize the wearer, via remote application, over a very long period. Certain embodiments of a location module can be used to locate lost personnel or personnel that have strayed into a hazardous area can be warned with the onboard haptics, for example. Certain embodiments of a location module can be used as a beacon to locate an incapacitated user by beaconing last location and emitting a beeping noise as search teams approach, for example.

Certain embodiments of a base station module can be deployed based on the terrain to maintain a mesh network and can be configured service whichever location modules are closest. Embodiments of the base station module can be deployed as needed to create a mesh network.

Certain embodiments of a location module can be made of low cost, but effective components to realize a very efficient long-range tracking system. Certain embodiments of a location module can act as a life-saving personnel tracking system. Certain embodiments of a location module can include a “911” function (e.g., by pressing a button) to simplify the transition of an emergency request call. Long range battery selection combined with intelligent software facilitate interrogation-based location over multiple days or weeks of use.

Certain embodiments can be used for MILES type kinematic training/gaming, as a component to compute pose estimation for AR/XR/VR systems, for long range tracking of personnel on training ranges. (EG>Land Navigation Ranges), as location device for lost personnel even when they are under concealment, and for equipment location, for example. Embodiments can provide emergency beaconing/broadcasting of location, sub-centimeter accuracy with RTK, emergency sound emission on demand, mesh networking for extended and dynamic range, sensors to assist in pose estimation, absolute, relative orientation output, a variety of extended battery lifetime modalities, active/Hi Resolution Tracking, e.g., with over 14 hours of active usage time, multiple days of intermittent use in power conserve mode, weeks of use in low power mode (intermittent beaconing), universal mounting point for a soldier, vehicle, helmet, weapon, etc., dead-reckoning measurement software available to cover in GPS denied conditions, LoRa, BLE, BT, WiFi communication standards, injury detection (with sensors detection), e.g., similar to vehicle crash detection, and haptic abilities. Certain embodiments can work as a MILES surrogate to provide “Hit” event notifications, can alert user to other events, and can provide in weapon line of sight, low battery warnings. Certain embodiments can provide position and orientation logging capabilities, real time beaconing supported with logged location events, “After Action Review”, shot detection when weapon used in conjunction with TDM, encrypted communication methods, water resistance, and AR, VR, XR, or HUD integration over an internal ICD, for example.

Embodiments can include any suitable computer hardware and/or software module(s) to perform any suitable function (e.g., as disclosed herein). As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A real-time position location system, comprising:
one or more location modules configured to be attached to a user or a weapon of the user and to output location data associated with each user;
one or more kinematic base station modules configured to receive the location data from each location module;
a position module operatively connected to the one or more kinematic base stations and configured to determine a real-time location of each of the one or more location modules and to output module position data for each of the one or more location modules in real-time.

2. The system of claim 1, further comprising one or more weapon tracking modules operatively associated with the weapon of the user and configured to provide weapon data to the one or more kinematic base station modules in real-time.

3. The system of claim 2, wherein the weapon data includes a trigger fire data that indicates whether a simulated shot has occurred, and a weapon orientation that indicates a directionality of the simulated shot.

4. The system of claim 3, further comprising a shot adjudication module operatively connected to the one or more kinematic base station modules to receive the weapon data of an associated user and the module position data of the associated user in real-time and to output shot trajectory data of the simulated shot based on the weapon data and the module position data of the associated user when the simulated shot occurred.

5. The system of claim 4, further comprising a hit module configured to receive the shot trajectory data and the position data of a second user and to determine if a position of the second user intersects the simulated shot in real-time based on the shot trajectory data to determine if the second user has been virtually hit by the simulated shot.

6. The system of claim 5, wherein the hit module comprises a terrain map and is configured to determine whether the second user is obscured by terrain such that the shot intersects terrain in front of the second user.

7. The system of claim 6, wherein the hit module is configured to determine an effect of the terrain and whether the shot would hit the second user through the terrain.

8. The system of claim 1, wherein the one or more location modules include an acoustic and/or haptic feedback system configured to alert the wearer of one or more events through acoustic and/or haptic feedback.

9. The system of claim 8, wherein the feedback system is configured to notify a user if they are hit by a simulated shot, or whether the user is out of bounds.

10. The system of claim 1, wherein the one or more location modules include a digital radio for bi-directional communication with the one or more kinematic base-station modules to provides localization enhancement to have precision within about a centimeter.

11. The system of claim 10, wherein the one or more location modules include one or more sensors configured to output sensor data to determine one or more user characteristics.

12. The system of claim 11, wherein the one or more user characteristics include at least one of head orientation, velocity, or local pressure conditions.

13. The system of claim 11, wherein each location module is configured to communicate its location data and sensor data over the digital radio to allow determination of ground truth location and orientation of the user.

14. The system of claim 1, wherein the one or more location modules include an internal battery, wherein the one or more location modules are configured to operate in a low power mode to enable use over multiple days without recharging.

15. The system of claim 14, wherein the low power mode includes intermittent listening for signals and/or intermittent transmission of signals.

16. The system of claim 15, the one or more location modules are configured to operate in a low power beacon mode configured to output intermittent beacon signals to locate a user in distress.

17. The system of claim 16, wherein the one or more location modules are configured to intermittently listen for a finder signal, and to output an acoustic signal as the finder signal is heard by the one or more location modules to help locate a user in distress.

18. The system of claim 1, wherein the one or more kinematic base station modules include a housing having a pole mount.

19. The system of claim 18, wherein the pole mount is a threaded opening.

20. The system of claim 11, wherein the one or more sensors include one or more inertial measurement units (IMU's) and/or one or more camera vision systems configured to provide motion data and/or position data when external location systems are inaccurate.
